(19) United States
(12) Patent Application Publication
(10) Pub. No.: US 2014/0160783 A1
(43) Pub. Date: Jun. 12, 2014

(54) LIGHT SOURCE ASSEMBLY FOR VEHICLE LIGHTING DEVICES

(71) Applicant: SAMSUNG ELECTRONICS CO., LTD., Suwon-si (KR)

(72) Inventors: Yeon Woo LEE, Seoul (KR); Young Jeong YOON, Suwon (KR)

(21) Appl. No.: 13/935,418

(22) Filed: Jul. 3, 2013

(30) Foreign Application Priority Data
Dec. 6, 2012 (KR) 10-2012-0141345

(51) Int. Cl. F21S 8/10; F21V 29/00

(52) U.S. Cl. CPC F21S 48/321; F21V 29/26
USPC 362/540; 362/382

(57) ABSTRACT

A light source assembly for a vehicle includes a frame having at least one device region; a heat radiator disposed above the at least one device region and spaced apart from the frame by a predetermined interval; a light source including at least one light emitting device disposed above the heat radiator in a position corresponding to the at least one device region; and an auxiliary heat radiator provided to the heat radiator by penetrating through the frame, thereby easily increasing and decreasing an amount of heat radiated by the heat radiator corresponding to an amount of heat generated by the light source.

### CROSS-REFERENCE TO RELATED APPLICATIONS

This application claims priority from Korean Patent Application No. 10-2012-0141345 filed on Dec. 6, 2012, in the Korean Intellectual Property Office, the disclosure of which is incorporated herein by reference in its entirety.

### TECHNICAL FIELD

The present disclosure relates generally to vehicle lighting systems, and particularly to lamp assemblies for vehicle lighting systems.

### BACKGROUND

Conventional vehicle lighting system components are generally manufactured to conform with the various shapes and sizes of different vehicle models. For example, in order to manufacture a light emitting device module and light source assembly suitable for a particular vehicle model, a custom mold or die corresponding to that vehicle model must first be manufactured. Thus, vehicle lighting component manufacturers may incur additional investment costs related to molding materials and equipment as well as additional manufacturing costs related to managing the molding process for different vehicle models.

In recent years, the use of high power light emitting diode (LED) light sources in vehicle lighting systems has grown in popularity. A vehicle light emitting device module using such a high power LED typically requires a heat radiator or heat sink for dissipating or releasing excessive heat produced by the high-power LED. However, the amount of heat that such a heat sink can radiate may be significantly limited by the relatively confined space within the interior of a vehicle in which the light emitting device module is installed.

### SUMMARY

An aspect of the present disclosure provides a light source assembly capable of easily increasing and decreasing an amount of heat radiated by a heat radiator corresponding to an amount of heat generated by a light emitting device module.

An aspect of the present disclosure also provides a turn signal lamp for a vehicle capable of easily increasing and decreasing an amount of heat radiated by a heat radiator corresponding to an amount of heat generated by a light emitting device module.

According to an aspect of the present disclosure, there is provided a light source assembly including: a frame having at least one device region; a heat radiator disposed above the at least one device region and spaced apart from the frame by a predetermined interval; a light source including at least one light emitting device disposed above the heat radiator in a position corresponding to the at least one device region; and an auxiliary heat radiator provided to the heat radiator by penetrating through the frame.

The at least one device region may include a plurality of device regions having different levels

The frame may include first frames including respective device regions and a second frame connecting the first frames to each other, and the first frames and the second frame may be reciprocally connected to each other to form an extended step structure.

The auxiliary heat radiator may be caught by a fixer provided on the frame, when provided to the heat radiator.

The frame may include a through hole through which the auxiliary heat radiator penetrates.

The fixer may be elastically provided in the through hole of the frame in contact with the auxiliary heat radiator in the device region and include a protrusion member protruding from a lateral surface of the through hole.

The auxiliary heat radiator may include a coupling hole into which the protrusion member is inserted, when provided to the frame.

The heat radiator may be attached to the auxiliary heat radiator.

The heat radiator may include a coupling groove guiding a position of the auxiliary heat radiator.

The light source may further include a substrate disposed between the at least one heat radiator and the at least one light emitting device and having the at least one light emitting device mounted thereon, and the substrate may be extended to allow the at least one heat radiator to be integrally connected.

The substrate may include a connector to which external power is applied.

The heat radiator and the auxiliary heat radiator may be made of the same material.

Thermal grease may be applied to a contact surface located between the heat radiator and the auxiliary heat radiator.

The plurality of device regions may have respective heat radiators.

According to another aspect of the present disclosure, a turn signal lamp for a vehicle includes: a light source assembly including a frame having at least one device region, a heat radiator disposed above the at least one device region and spaced apart from the frame by a predetermined interval, a light source including at least one light emitting device disposed above the heat radiator in a position corresponding to the at least one device region, and an auxiliary heat radiator provided to the heat radiator by penetrating through the frame; a rear cover to which the frame is fixed; and a lens cover releasing light emitted from the light source outwardly and combined with the rear cover.

### BRIEF DESCRIPTION OF THE DRAWINGS

The various aspects, features and other advantages of the present disclosure will be more clearly understood from the following detailed description taken in conjunction with the following figures.

FIG. 1 is a schematic perspective view illustrating a light source assembly.

FIG. 2 is a side cross-sectional view of the light source assembly of FIG. 1.

FIG. 3 is a side cross-sectional view of the light source assembly before auxiliary heat radiators are combined with a frame of FIG. 2.

FIG. 4 is a perspective view of a contact surface between a heat radiator and an auxiliary heat radiator.

FIGS. 5A through 5C are schematic views illustrating an operational state of a fixer in the light source assembly of FIG. 1.

### DETAILED DESCRIPTION OF THE EMBODIMENTS

Hereinafter, embodiments of the present disclosure will be described in detail with reference to the accompanying drawings.

The disclosed subject matter may, however, be exemplified in many different forms and should not be construed as being limited to the specific embodiments set forth herein. Rather, these embodiments are provided so that this disclosure will be thorough and complete, and will fully convey the scope of the subject matter described herein to those skilled in the art.

In the drawings, the shapes and dimensions of elements may be exaggerated for clarity, and like reference numerals will be used throughout to denote the same or similar elements.

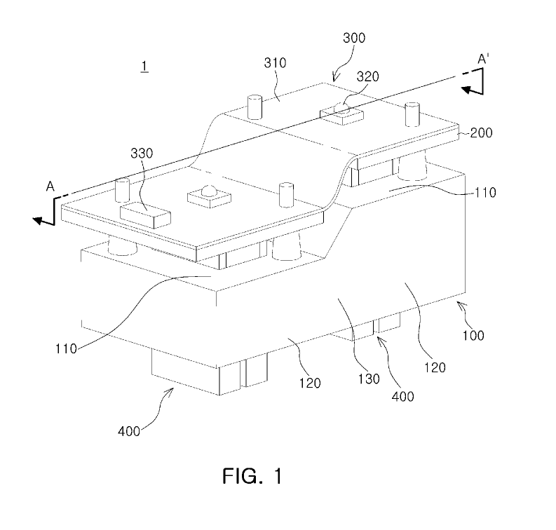

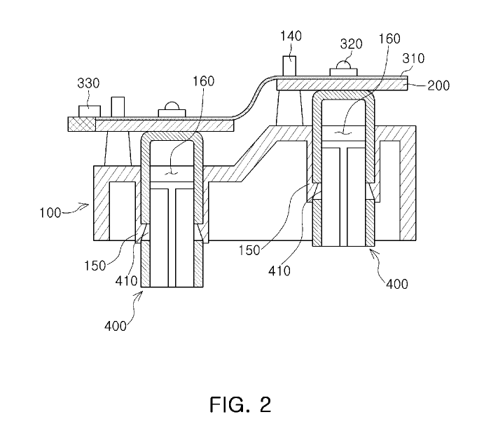

FIG. 1 illustrates an exemplary light source assembly according to an embodiment. As will be described in further detail below, FIG. 2 is aside cross-sectional view of the light source assembly of FIG. 1, taken along line A-A′. As shown in FIG. 1, a light source assembly 1 includes a frame 100, a heat radiator 200, a light source 300 and an auxiliary heat radiator 400.

The frame 100 has at least one or more device regions 110, and may be formed by injection molding of an insulating resin. The frame 100 may be used in the light source assembly for any of the various lighting devices of a vehicle including, for example and without limitation, a headlamp, a turn signal lamp, a brake light and the like.

Also, as shown in FIG. 1, the frame 100 includes device regions 110 according to an embodiment. Further, the frame 100 includes first frames 120A and 120B having respective device regions 110 above which the heat radiator 200 is disposed. A second frame 130 may be used to connect the first frames 120A and 120B with each other. Here, the second frame 130 may be extended from the first frames 120A and 120B in an angular direction so as to be placed in an incline position relative to the first frames. In this example, the first frames 120A and 120B and the second frame 130 are reciprocally connected to each other to form an extended step structure. Accordingly, the respective device regions 110 associated with the first frames 120A and 120B may be located at different levels of the step structure. For example, the plurality of device regions 110 may be disposed at different heights within the light source assembly, as shown in FIG. 1.

In the example shown in FIG. 1, the frame 100 includes two device regions 110. However, the disclosed subject matter is not intended to be limited thereto. Thus, frame 100 may include any number of device regions 110 in other embodiments, based on, for example, the particular vehicle models for which the light source assembly may be designed.

As described above, the first frames 120A and 120B may include respective device regions 110 above which the heat radiator 200 is disposed. Each of the first frames 120A and 120B may also include sidewalls that extend from the sides of the respective device regions 110.

In an example, the second frame 130 is placed between the first frames 120A and 120B such that one end of the second frame 130 extends from a sidewall of the first frame 120A while the other end is extends from a portion of a sidewall of the other first frame 120B. In this way, the first frames 120A and 120B in conjunction with the second frame 130 form integrated structure.

In this example, the device regions 110 are quadrangular shaped regions with sidewalls forming four lateral surfaces. However, the device regions 110 are not limited to any particular shape. Furthermore, the first frames 120A and 120B formed by the respective device regions 110 and the sidewalls may have various shapes including, but not limited to, quadrangular, hexagonal, cylindrical pillars and the like.

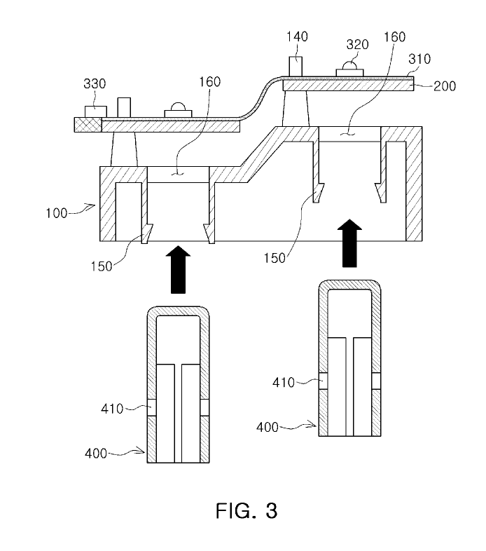

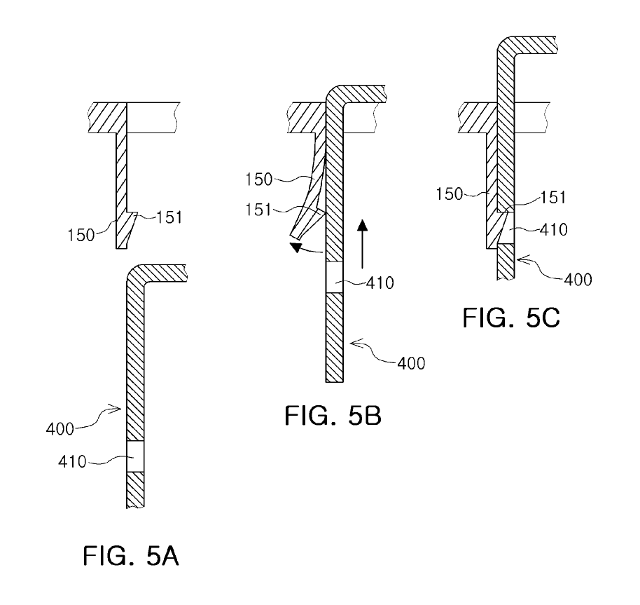

As shown in FIGS. 2 and 3, each of the device regions 110 includes a through-hole 160, through which an auxiliary heat radiator 400 may be inserted. Thus, each through-hole 160 may be formed within the respective device regions 110 so as to have a predetermined size that is sufficient to allow the corresponding auxiliary heat radiator 400 to penetrate therethrough. As will be described in further detail below with respect to FIGS. 5A-5C, a fixing 150 including a protrusion member 151, as shown in FIGS. 5A-5C, may be extended from a lateral surface of the through-hole 160 such that the auxiliary heat radiator 400 may be fixed and coupled to the lateral surface of the through-hole 160. Although only fixing 150 and protrusion member 151 are shown in the examples of FIGS. 2, 3, and 5A-5C, it should be noted that the subject matter disclosed herein is not intended to be limited thereto and that any of various types of physical members or attachment mechanisms may be used for fixing the auxiliary heat radiator 400 to the frame 100 using the through-hole 160.

As shown in FIGS. 1 and 2, the heat radiator 200 may be a type of heat sink disposed in the respective device regions 110. The functions of the heat radiator 200 may include, for example, supporting the light source 300 and outwardly releasing heat generated by the light source 300. The heat radiator 200 may be spaced apart from each of the device regions 110 of the frame 100 by a predetermined distance or interval, such that a pathway for allowing air to flow between the heat radiator 200 and respective device regions 110 is formed. In this way, heat is radiated from the heat radiator 200 through natural convection, and radiation efficiency may be improved as compared with a structure in which a heat radiator is in contact with a frame.

In an example, the heat radiator 200 is heated due to the heat generated by the light source 300, and the heat radiator 200 radiates the heat to the surrounding air. Particularly, as the air below the heat radiator 200 is heated, heat is transferred to a lateral surface of the heat radiator 200 through natural convection, such that the heat may be radiated outwardly from the heat radiator 200. In addition, in a case where a plurality of heat radiators 200 are disposed to have a step structure corresponding to that of the frame 100, the air below the plurality of heat radiators 200 may flow unidirectionally due to a difference in heights between the plurality of heat radiators 200. This may also allow radiation efficiency to be further improved.

The heat radiator 200 may be formed as a plate having a shape corresponding to that of the respective device regions 110, but is not limited thereto. Accordingly, the heat radiator 200 may have a different shape from that of the device region 110. In some implementations, the heat radiator 200 may be formed as a single metallic plate.

As described above, the heat radiator 200 may be disposed to be spaced apart from the device region 110 of the frame 100 by a predetermined interval. As shown in FIGS. 2 and 3, this spacing may be achieved by using a support member 140 provided on the device region 110. For example, at least one support member 140 may be formed to protrude outwardly from the device region 110, and the heat radiator 200 may be fixed by the at least one support member 140. The fixing of the heat radiator 200 may be performed using any of various methods including, but not limited to, an adhesive, heat fusion, screws, and the like. In addition, in the case in which the plurality of heat radiators 200 are disposed above the frame 100, they may be arranged to have a step structure corresponding to that of the frame 100.

In an example, the heat radiator 200 has a quadrangular plate structure and one or more support members 140 are used to fix opposite end portions of the heat radiator 200. However, the present disclosure is not limited thereto and any of various structures and arrangements may be used to fix the heat radiator 200 to the frame 100 using the support member(s) 140.

The heat radiator 200 may be made of a metal having a high level of heat conductivity in order to improve radiation efficiency. In addition, a progressive die, a semi-progressive die or a die-casting die may be used for mass production thereof.

The light source 300 disposed above the heat radiator 200 may include a substrate 310 disposed on the plurality of heat radiators 200. Additionally, a plurality of light emitting devices 320 may be mounted on the substrate 310 so as to be disposed in positions corresponding to the respective device regions 110. As shown in FIGS. 1-3, a connector 330 is provided on an end portion of the substrate 310 in order to make a connection with an external power source.

The substrate 310 may be connected to the plurality of heat radiators 200 and may be extended to connect the plurality of heat radiators 200 to be integrated with each other. The substrate 310 may also have a step structure corresponding to the step structure of the frame 100 and the plurality of heat radiators 200 disposed above the frame 100. Therefore, the substrate 310 may be a flexible printed circuit board (FPCB) that can be easily bent at different positions of the plurality of heat radiators 200 in order to match the step structure of the frame 100 and plurality of heat radiators 200. The substrate 310 may be attached to the heat radiators 200 using, for example, an adhesive or the like.

The light emitting device 320 may be, for example, a semiconductor device capable of emitting light having a predetermined wavelength when external power is applied thereto. The light emitting device 320 may include a light emitting diode (LED). The light emitting device 320 may emit white light as well as blue, green or red colored light according to the particular materials that it includes.

A light emitting device 320 may be disposed in each of the device regions 110, or a plurality of light emitting devices 320 may be disposed in a single device region 110. In the case in which the plurality of light emitting devices 320 are disposed in the single device region 110, either homogeneous light emitting devices generating light of the same wavelength or heterogeneous light emitting devices generating light of different wavelengths may be used. In addition, the plurality of light emitting devices 320 may be variously configured according to the power levels of the corresponding LEDs, for example, 0.5 W LEDs and 1 W LEDs. The light emitting device 320 may be an LED chip itself or an LED package including an LED chip provided therein. The plurality of light emitting devices 320 may be arranged to have a step structure corresponding to the arrangement of the device regions 110 and the heat radiators 200 mounted thereon.

The auxiliary heat radiator 400 may be disposed below the heat radiator 200 in order to increase an amount of heat radiated by the heat radiator 200. A cross-section of the auxiliary heat radiator 400 may correspond to that of the through-hole 160 such that the auxiliary heat radiator 400 penetrates through the through-hole 160 of the frame 100 so as to be positioned below the heat radiator 200. Similar to the heat radiator 200, the auxiliary heat radiator 400 may be made of a metal having a high level of heat conductivity in order to improve radiation efficiency. The auxiliary heat radiator 400 may be made of the same metal as that of the heat radiator 200. In addition, the auxiliary heat radiator 400 may be made of a metal having a higher level of heat conductivity than that of the heat radiator 200, in order to make it more effective at releasing the heat radiated by the heat radiator 200.

As described above, the auxiliary heat radiator 400 may be provided to the heat radiator 200 by being coupled to the protrusion member 151 of the frame 100. The auxiliary heat radiator 400 may have a coupling hole 410 in a lateral surface thereof in contact with the protrusion member 151. The protrusion member 151 may be elastically coupled to the coupling hole 410.

As shown in FIGS. 5A through 5C, a fixer 150 pushed outwardly by the auxiliary heat radiator 400 may be returned to an original position when the protrusion member 151 is inserted into the coupling hole 410. Therefore, the auxiliary heat radiator 400 may be stably fixed to the frame 100, when the protrusion member 151 of the fixer 150 is inserted into and caught by the coupling hole 410 formed in the auxiliary heat radiator 400. When the protrusion member 151 is outside of the coupling hole 410, the auxiliary heat radiator 400 may be easily detached from the frame 100. In this manner, the auxiliary heat radiators 400 may be easily coupled to the heat radiators 200, even while having different lengths, e.g., depending on the amount of heat to be radiated from the light emitting devices 320 provided in the light source 300. Therefore, even when the amount of heat generated by the light emitting devices 320 in the light source assembly 1 is increased, only the auxiliary heat radiators 400 need to be exchanged or replaced, whereby the maintenance and repairs of the light source assembly 1 may be facilitated.

The method for providing or coupling the auxiliary heat radiator 400 to the heat radiator 200 may be performed using any of various techniques and is not limited to the above-described techniques. For example, the auxiliary heat radiator 400 may be attached to a lower portion of the heat radiator using an adhesive or may be fixed thereto using screws.

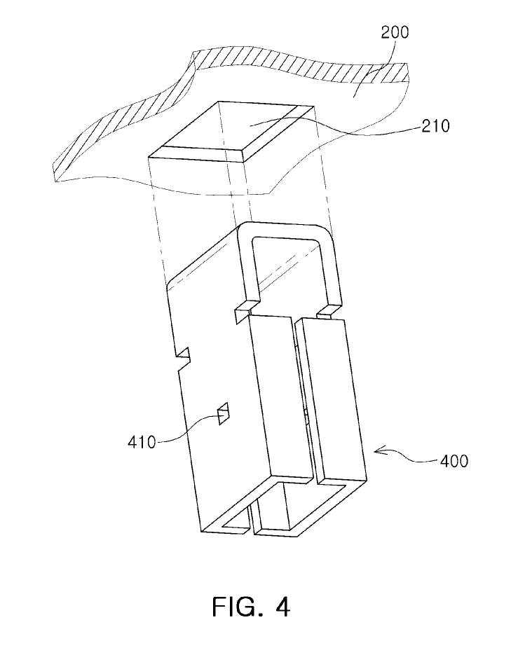

In the example shown in FIG. 4, a coupling groove 210 is formed in a surface of the heat radiator 200 in contact with the auxiliary heat radiator 400. The coupling groove 210 may be used to position or guide the auxiliary heat radiator 400 into a desired position. In this manner, the auxiliary heat radiator 400 may be further stably provided to the heat radiator 200. In addition, thermal grease is applied to the contact surface between the heat radiator and the auxiliary heat radiator 400, thereby further increasing an amount of heat conducted from the heat radiator 200 to the auxiliary heat radiator 400.

A rear cover for fixing the frame 100 is provided on a rear surface of the light source assembly 1 and a lens cover is provided on a front surface of the light source assembly 1. The lens cover may be combined with the rear cover in order to release light emitted from the light source 300 in an outward direction. This configuration of the light source assembly 1 may be used in, for example, a turn signal lamp for a vehicle.

Advantages of the present disclosure as described herein include, but are not limited to, providing a light source assembly for a vehicle lighting system component (e.g., a turn signal lamp), which can be easily adjusted so as to increase or decrease an amount of heat radiated by a heat radiator relative to an amount of heat generated by a light emitting device module within the light source assembly.

While the present disclosure has been shown and described in connection with various embodiments, it will be apparent to those skilled in the art that modifications and variations can be made without departing from the spirit and scope of this disclosure as defined by the appended claims.

What is claimed is:

1. A light source assembly comprising:
a frame having at least one device region;
a heat radiator disposed above the at least one device region and spaced apart from the frame by a predetermined interval;
a light source including at least one light emitting device disposed above the heat radiator in a position corresponding to the at least one device region; and
an auxiliary heat radiator configured to attach to the heat radiator through the at least one device region of the frame, and to radiate heat generated by the light source via the heat radiator.

2. The light source assembly of claim 1, wherein the at least one device region comprises a plurality of device regions having different levels.

3. The light source assembly of claim 2, wherein the frame includes first frames including respective device regions and a second frame connecting the first frames to each other, and
the first frames and the second frame are reciprocally connected to each other to form an extended step structure.

4. The light source assembly of claim 1, wherein the auxiliary heat radiator attaches to the heat radiator via a fixer of the frame.

5. The light source assembly of claim 4, wherein the frame includes a through hole within the at least device region through which the auxiliary heat radiator is inserted for attaching to the heat radiator.

6. The light source assembly of claim 5, wherein the fixer is elastically provided in the through hole of the frame in contact with the auxiliary heat radiator in the device region and includes a protrusion member protruding from a lateral surface of the through hole.

7. The light source assembly of claim 6, wherein the auxiliary heat radiator includes a coupling hole into which the protrusion member is inserted, when the auxiliary heat radiator is inserted through the through hole of the frame.

8. The light source assembly of claim 1, wherein the auxiliary heat radiator is detachable from the heat radiator, so as to enable the auxiliary heat radiator to be replaced with another auxiliary heat radiator to be attached to the heat radiator.

9. The light source assembly of claim 1, wherein the heat radiator includes a coupling groove for positioning the auxiliary heat radiator.

10. The light source assembly of claim 1, wherein the light source further includes a substrate disposed between the at least one heat radiator and the at least one light emitting device, the substrate having the at least one light emitting device mounted thereon, and
the substrate is extended to allow the at least one heat radiator to be integrally connected.

11. The light source assembly of claim 10, wherein the substrate includes a connector for connecting an external power source.

12. The light source assembly of claim 1, wherein the heat radiator and the auxiliary heat radiator are made of the same material.

13. The light source assembly of claim 1, wherein thermal grease is applied to a contact surface between the heat radiator and the auxiliary heat radiator.

14. The light source assembly of claim 2, wherein the plurality of device regions have respective heat radiators.

15. A turn signal lamp for a vehicle, comprising:
a light source assembly including a frame having at least one device region, a heat radiator disposed above the at least one device region and spaced apart from the frame by a predetermined interval, a light source including at least one light emitting device disposed above the heat radiator in a position corresponding to the at least one device region, and an auxiliary heat radiator provided to the heat radiator by penetrating through the frame;
a rear cover to which the frame is fixed; and
a lens cover releasing light emitted from the light source outwardly and combined with the rear cover.

16. The turn signal lamp of claim 15, wherein the auxiliary heat radiator of the light source assembly is attached to the heat radiator through the at least one device region of the frame for radiating heat generated by the light source.

17. The turn signal lamp of claim 15, wherein the at least one device region of the light source assembly comprises a plurality of device regions having different levels.

18. The turn signal lamp of claim 17, wherein the frame includes first frames including respective device regions and a second frame connecting the first frames to each other, and
the first frames and the second frame are reciprocally connected to each other to form an extended step structure.

19. The turn signal lamp of claim 15, wherein the auxiliary heat radiator of the light source assembly attaches to the heat radiator via a fixing of the frame.

20. The turn signal lamp of claim 19, wherein the frame of the light source assembly includes a through hole within the at least device region through which the auxiliary heat radiator is inserted for attaching to the heat radiator.
